(19) United States
(12) Patent Application Publication
(10) Pub. No.: US 2012/0098434 A1
(43) Pub. Date: Apr. 26, 2012

(54) LED LIGHT ASSEMBLY AND ASSOCIATED METHOD

(75) Inventor: John H. Sondericker, III, Colorado Springs, CO (US)

(73) Assignee: WYBRON, INC., Colorado Springs, CO (US)

(21) Appl. No.: 12/912,372

(22) Filed: Oct. 26, 2010

(51) Int. Cl. H01J 13/32; F21S 4/00; H05B 37/02; H01J 61/52

(52) U.S. Cl. 315/113; 315/117; 362/249.02; 315/294

(57) ABSTRACT

A light assembly, and an associated method, provides color-mixed light generated by light emitter diode elements. A temperature sensor is position to sense temperature levels proximate to the LED light-emitter elements. And, a coolant flow generator is configured in a feedback arrangement to generate coolant fluid to dissipate thermal energy generated during operation of the LED elements to maintain the temperature levels at a constant temperature or within an allowable range.

The present invention relates generally to a light assembly, such as a light assembly used to illuminate an object that utilizes LED (Light Emitting Diode) lights. More particularly, the present invention relates to an LED light assembly, and an associated method, that utilizes a plurality of multiple-LED elements, arranged in an array and that maintains a temperature level substantially constant in proximity to the LED elements.

The LED assembly provides light energy of consistent characteristics, relative to an applied power level, that also is of improved color mixing characteristics.

### BACKGROUND OF THE INVENTION

Lighting devices are used to provide artificial illumination pursuant to many various light functions. Lighting devices are constructed to generate light energy forming a lamp output of various light intensities and various colors. And, while many of such light devices are needed merely to generate a lamp output of static, non-changing attributes, some lighting functions require the light energy provided by such lighting devices to form lamp outputs that are dynamically alterable.

For instance, entertainment lighting, such as lighting devices whose lamp output is directed towards a stage performer or otherwise associated with, e.g., stage with theatrical lighting, sometimes requires the light characteristics to be changeably, quickly, over a wide range of intensities and colors.

Lighting devices are sometimes supported at, or form part of light fixtures. Additional structure, such as light color-changing apparatus is also sometimes supported at, or forms a portion of, a light fixture.

Lighting devices conventionally comprise incandescent light sources. Other types of discharge light sources are sometimes alternately used, such as high intensity discharge (HID) or florescent lamps. While incandescent light sources have long been used and generate white light energy of high intensity levels, a significant portion of the energy applied to an incandescent light source to power the light source is dissipated as heat energy and is not converted into visible light energy. High intensity discharge, florescent and other gas-discharge lamps, in contrast, is generally more efficient in that a greater proportion of the applied energy is converted into light energy. These types of lamps are more typically used when high levels of light energy over large areas are required or in which high energy efficiency is required.

Some gas-discharge lamps, however, have a low color rendering index, resulting in color distortion of objects that are illuminated by the gas-discharge lamp, light energy.

Light fixtures also sometimes include devices to control the light output intensity generated by such conventional incandescent or gas-discharge lamps. These intensity-controlling devices include devices that control the electrical power that is applied to the incandescent or gas-discharge lamps. The intensity level of light energy generated by an incandescent lamp, for instance, is controlled by rising or lowering the voltage or current applied to the lamp or by adjusting the frequency of power that is applied to the lamp. However, when the intensity of the light energy is altered at an incandescent lamp in this manner, the color temperature and color spectrum of the light energy is also altered. For instance, when an incandescent lamp is dimmed by reducing the power applied thereto, the light output is shifted towards the red-frequency end of the light spectrum.

The light intensity of light energy generated by high intensity discharge, and other gas-discharge, lamps is also sometimes controlled in analogous manner. These lamps also, however, suffer from a similar disadvantage as that exhibited by incandescent lamps. That is to say, changing the light intensity of a gas-discharge lamp also causes shifting of the color temperature and the color spectrum of the light energy. Dimming of the light output of a gas-discharge lamp shifts the light output towards the blue-end of the light spectrum. Furthermore, the extent of the dimming that is possible in this manner is also limited. That is to say, the range of the dimming is limited. For instance, a high intensity discharge lamp is able to be dimmed down to about fifty percent of its full output. But, the dimming cannot continue down to a zero output.

More recently, LED (Light Emitting Diode) have been developed that are capable of generating light energy of intensity levels great enough to provide illumination of objects, analogous to the illumination provided by conventional incandescent and gas-discharge lamps. While the light intensity generated by a single LED lamp is small compared to the intensity permitted to be provided by conventional devices, the relatively smaller dimensions of LED lamps permit groups of lamps to be positioned together. Their collective light output, i.e., light intensity, approaches that of, and is acceptable as substitution for, conventional incandescent and gas-discharge lamps. LED lamps are advantageous for the reason that the devices are relatively efficient and are long-lasting.

However, the light characteristics of the lamp output of LED devices changes as a function of temperature. That is to say, at different operating temperatures, the lamp output of an LED lamp differs with the lamp output at other temperatures. Additionally, if the operating temperature about a LED lamp exceeds a maximum threshold, LED lamp is susceptible to permanent damage, permanently reducing the light-intensity capability of the lamp. Furthermore, different color LED elements, either in discrete or multi-element packages, react with a non-linear or dissimilar output level across a range of operating temperatures. This dissimilar output power response across a range of operating temperatures causes a relative change in the magnitudes of the individual colors being created by the lighting fixture which results in a color shift when the light is viewed on the intended target.

Therefore, while lighting devices utilizing LED lamps provide advantageous over lighting devices utilizing conventional lamps, challenges remain in their use, particularly in high-intensity lighting applications.

It is in light of this background information related to light devices that the significant improvements of the present invention have evolved.

### SUMMARY

The present invention, accordingly, advantageously provides an apparatus, and an associated method, for a light assembly, such as a light assembly used to illuminate an object, that utilizes LED (Light Emitting Diode) lights.

Through operation of an embodiment of the present invention, a manner is provided by which to illuminate an object utilizing a plurality of multiple-LED elements. The multiple LED elements are arranged in an array, and the mounting-substrate temperature levels in proximity to the LED elements are maintained at substantially constant temperature levels.

In one aspect of the present invention, the characteristics of the light energy generated during operation of the LED light assembly are caused to be of consistent characteristics relative to an applied power level. The color mixing characteristics of the light energy are also improved relative to conventional light assemblies utilizing LED lights.

In another aspect of the present invention, a temperature sensor is provided for a light assembly that utilizes an LED light source. The temperature sensor is positioned in proximity to the LED light source and, so-positioned, senses operating temperature levels at the LED light source. The temperature sensor is capable of at least sensing when the operating temperature level exceeds a high temperature threshold. In one implementation, the temperature sensor is capable of sensing multiple temperature thresholds including, e.g., a low temperature threshold and an overheated temperature threshold. And, in a further implementation, the temperature sensor is capable of sensing operating temperature levels in proximity to the LED light source in whose proximity that the temperature sensor is positioned.

In another aspect of the present invention, a coolant flow generator is provided for the light assembly, configured to generate a flow of coolant fluid when operated. The coolant flow generator is configured in a manner in which the coolant fluid, when generated, is caused to dissipate thermal energy proximate to the LED light source so that the temperature level proximate to the LED light source is affected. The coolant flow generator comprises, for instance, a variable-speed electrical fan that, when operated, generates an airflow that is directed in a manner to dissipate the thermal energy.

In another aspect of the present invention, the temperature sensor is connected, or otherwise arranged, in a feedback arrangement with the coolant flow generator. When so-configured, the temperature sensed by the temperature sensor is used to control operation of the coolant flow generator. The temperature sensor provides an indication at least when the temperature level proximate to the LED light source is beyond the high temperature threshold. The coolant flow generator is caused, in response to the indication, to generate the coolant fluid flow to dissipate the thermal energy and, thereby to control the temperature level in proximity to the LED light source.

In another aspect of the present invention, the coolant flow generator is further capable of generating coolant fluid flow at various flow rates. And, the temperature sensor is capable of sensing temperature levels in proximity to the LED light source. The coolant flow generator is configured, responsive to sensed indications, sensed by the temperature sensor, to cause generation of coolant fluid flow at a flow rate dependent upon the sensed indications.

In another aspect of the present invention, the configuration of the temperature sensor and the coolant flow generator in the feedback arrangement permits control of the substrate temperature level in proximity to the LED light source to maintain the temperature level at a substantially constant level. When an increased temperature gradient is sensed by the temperature sensor, the temperature sensor provides an indication that causes the coolant flow generator to generate coolant fluid flow to dissipate the coolant energy. And, when the sensed temperature is indicated to be in conformity with an acceptable level, the coolant flow generator is caused to reduce, or terminate, the generation of the coolant flow.

In another aspect of the present invention, the LED light source is positioned upon a substrate. And, the substrate is seated at a heat sink. The substrate, in one implementation, comprises a printed circuit board having a metallic, or other thermally-conductive, middle layer. The heat sink is configured to conduct away thermal energy, such as thermal energy generated during operation of the LED light source. In one implementation, the heat sink is formed integral with a housing of a light assembly of which the LED light source, substrate, coolant flow generator, and heat sink comprise portions.

In another aspect of the present invention, the substrate, heat sink, and coolant flow generator are positioned in-line with one another. That is to say, the coolant flow generator is positioned to direct coolant fluid flow towards the heat sink that, in turn, is positioned to conduct away thermal energy from the substrate and are proximate to the LED light source. Thereby, by causing dissipation of the thermal energy away from the heat sink, the coolant fluid flow causes cooling of, or prevents the buildup of thermal energy proximate to, the LED light source, thereby to maintain the temperature level proximate to the LED light source at an acceptable level.

In another aspect of the present invention, the LED light source is comprised of a plurality of multiple, light-emitter elements. The elements are supported at a substrate in an array configuration. That is to say, individual ones of the multiple, light-emitter elements are supported at positions of the substrate to form an array of the elements. And, when supplied with operative power, the individual elements generate light energy that collectively defines a lamp output. Improved chromatic consistency is provided across a light beam forming the lamp output. And, resultant, uniform lighting of a subject is better provided.

In another aspect of the present invention, the multiple, light-emitter elements comprise quad LED elements with each quad LED element having four LED emitters. The LED emitters of the quad LED element include, for instance, a red LED emitter, a yellow LED emitter, a blue LED emitter, and a white LED emitter. In other implementations, the multiple, light-emitter elements are comprised of other numbers and colors of LED light emitters. The array into which the LED light-emitter elements are arranged comprises, e.g., a rectangular array or a circular array. In one implementation, the light-emitter elements are grouped into groups of four-element groups with each element of the group rotationally offset from another element in the group by approximately 90 degrees. Thereby, the different ones of the light-emitter elements of the group have different-colored LED emitters in different quadrants defined by each of the quad-emitter elements. Analogously, in an implementation in which the light-emitter elements are configured in a circular, or other radio-like array, the individual ones of the light-emitter elements are rotationally offset from other elements. For instance, adjacent-positioned elements of the array are rotationally offset from elements adjacent thereto. Improved chromatic consistency is provided across a light beam forming the lamp output. And, resultant, uniform lighting of a subject is better provided.

In these and other aspects, therefore, an apparatus, and an associated method, is provided for regulating a temperature level at a light assembly. The light assembly has an LED light source. A temperature sensor is positioned in proximity to the LED light source. The temperature sensor is configured at least to sense when a temperature level at the LED light source exceeds a high temperature threshold. A coolant flow generator is configured to generate coolant fluid flow responsive to sensing by the temperature sensor that the temperature level exceeds the high temperature threshold, thereby to regulate the temperature level in proximity to the LED light source.

In these and further aspects, therefore, further apparatus, and an associated method, is provided for a light assembly. A group of multiple LED elements is provided. Each multiple LED element is comprised of multiple LED light emitters. A substrate is configured to support the multiple LED elements of the group in an array configuration. Individual ones of the multiple LED elements of the group are rotationally offset from others of the group.

A more complete appreciation of the scope of the present invention and the manner in which it achieves the above-noted and other improvements can be obtained by reference to the following detailed description of presently preferred embodiments taken in connection with the accompanying drawings that are briefly summarized below, and by reference to the appended claims.

### BRIEF DESCRIPTION OF THE DRAWINGS

FIG. 1 illustrates a functional block diagram of a light assembly of an embodiment of the present invention.

FIG. 2 illustrates an exploded, perspective view of a portion of the light assembly shown in FIG. 1.

FIG. 3 illustrates an exemplary arrangement of LED light-emitter elements forming the LED light source of an embodiment of the present invention.

FIG. 4 illustrates another exemplary arrangement of LED, light-emitters forming the LED light source of another embodiment of the present invention.

FIG. 5 illustrates a method flow diagram representative of the method of operation of an embodiment of the present invention.

### DETAILED DESCRIPTION

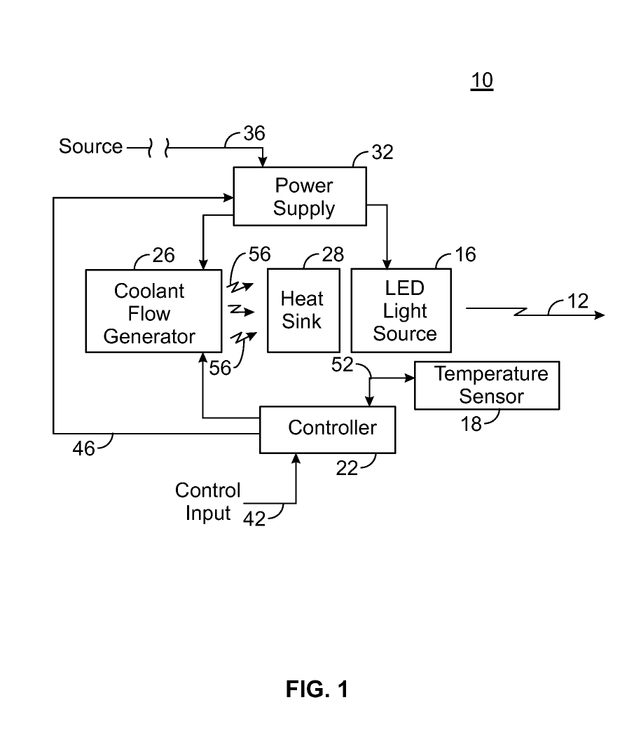

Turning first, therefore, to FIG. 1, a light assembly, shown generally at 10, operates to generate light energy defining a lamp output, here represented by the arrow 12. The light assembly, in the exemplary implementation, comprises a high-power light assembly capable of generating light energy of high intensity, such as light energy generated pursuant to a stage-lighting application. While the following description of exemplary operation of the light assembly 10 shall be described with respect its implementation in which the light assembly is constructed as a stage light, in other implementations, the light assembly is configured to generate light energy pursuant to effectuation of other lighting applications. Additionally, while the elements of the light assembly are functionally represented, the elements are implemented in any desired manner that provides the functionalities of the respective elements.

The light assembly 10 is here shown to include an LED (Light Emitting Diode) light source 16, a temperature sensor 18, a controller 22, a coolant flow generator 26, a heat sink 28, and a power source 32.

The power source 32 provides power that powers the LED light source 16 and the coolant flow generator 26. The power provided by the power source 32 is, e.g., supplied by a power supply (not separately shown), provided to the power source by way of a power-supply line 36. The power is sourced, for instance, at a public electrical grid, and the power source operates to convert the provided energy into energy of characteristics permitting powering of the LED light source 16 and coolant flow generator 26.

The light assembly 10 is operated responsive to external commands provided to the light assembly, here indicated by way of the line 42 that extends to the controller 22. The commands are, for example, automated commands, such as those generated by a programmatic sequence or by manual selection. And, line 42 is alternately a wired connection or a radio, i.e., wireless, connection.

The commands provided to the controller identify, for instance, the times, e.g., in terms of durations, during which the LED light source 16 should be powered and the power levels at which the LED light source should be powered to control the light intensity of its lamp output. Here, the controller 22 causes the operation of the light assembly in conformity with the commands provided thereto by controlling the power provided by the power source 32 to power the LED light source 16. The line 46 is representative of a line upon which control signals are provided by the controller to control the power source power application to the light source 16.

The temperature sensor 18 comprises one or more temperature sensors positioned proximate to the LED light source. Temperatures sensed by the temperature sensor are representative of the temperatures in proximity to a light source 16. That is to say, here, the sensed temperatures are of a substrate at which the LED light source is positioned, and, thereby, also of the LED light source. In the exemplary implementation, the temperature sensor senses the temperature and provides indications of the sensed temperatures on the line 52 to provide the controller with indications of the sensed temperatures. In an alternate implementation, the temperature sensor senses when the temperature threshold have been exceeded and provides indications of when such set point have been exceeded to the controller 22.

The controller further operates to control operation of the coolant flow generator 26. When the controller detects that the sensed temperature begins to elevate, such as to be elevated beyond a threshold or temperature gradient, the controller causes the coolant flow generator to be operated and to generate coolant fluid, here coolant air indicated by the arrows 56. In one implementation, the coolant flow generator is a variable speed generator, that is, is operable to generate a variable amount of coolant flow depending upon the rate of generation by the generator 26. The rate is controlled by command generated by the controller 22.

Through suitable arrangement of the temperature sensor and the coolant flow generator, the temperature at the LED light source can be maintained at a substantially constant temperature, or within a narrow range of temperatures. When a temperature increase is sensed, coolant fluid is caused to be generated, at a rate to compensate for thermal energy generated during operation of the light assembly. The sensed temperature forms a feedback loop that is used to control the rate of coolant fluid flow.

In the exemplary implementation, the heat sink 28 is positioned in-line, between the coolant flow generator and the LED light source 16. Specifically, the heat sink is positioned in-line with the coolant fluid generated by the generator 26.

And, thermal energy of the heat sink is conducted away. The heat sink, in this implementation, is positioned to abut against the substrate upon which the LED light source 16 is mounted. Heat energy generated during operation of the light source is conducted to the heat sink 28 to be dissipated thereat. Application of the fluid facilitates dissipation of the thermal energy conducted to the heat sink.

By positioning and maintaining the heat sink in abutting engagement with the thermally conductive substrate and light source 16, efficient conduction of the heat energy generated during operation of the light assembly to this heat sink is made. And, by positioning the coolant flow generator 26 to direct the coolant fluid in the direction of the heat sink, thermal energy is more quickly dissipated therefrom.

By maintaining the LED light source 16 at a substantially constant temperature, the light characteristics of the light energy generated by the light source is constant and does not change as a function of the power setting as the temperature does not change.

In a further implementation, the controller is further operable to cause the amount of power applied to the LED light source to be reduced in the event of the occurrence of an overheating condition. In the event that coolant fluid flow fails to dissipate heat energy generated during operation of the light assembly, or otherwise existent thereat, the maximum permitted power level that is permitted to be applied to the LED light source is reduced, or even prohibited. Such operation reduces the possibility of permanent damage and permanent diminution of the lamp output of the LED light source.

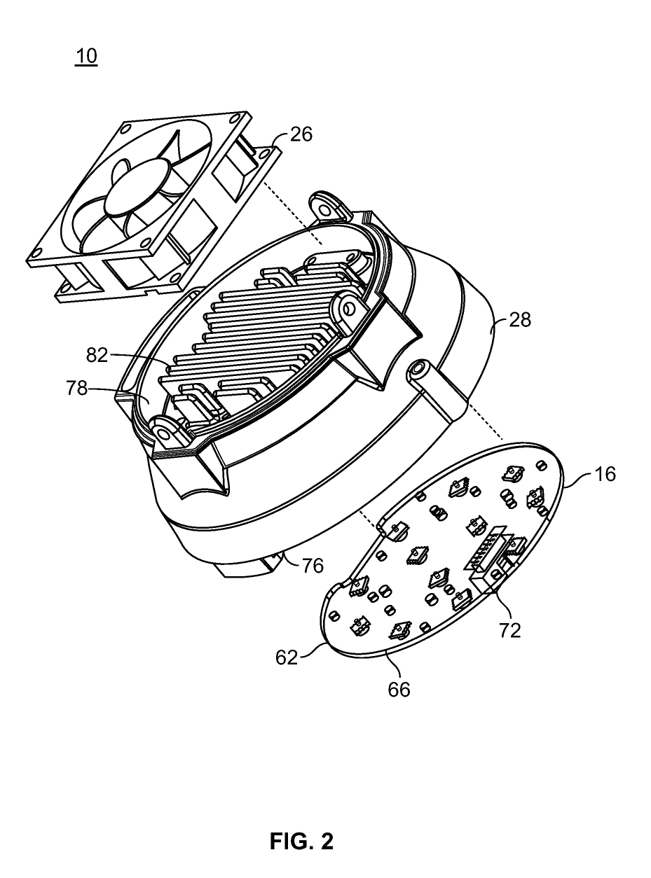

FIG. 2 illustrates a portion of the light assembly 10 shown in FIG. 1. Here, the LED light source 16, the coolant flow generator 26, and the heat sink 28 are illustrated. The LED light source 16 is here shown to form a substantially circular, planar substrate at which LED emitters 66 is mounted. Only back-ends of the LED emitters are shown in the view of the figure. The LED light emitters 66 are electrically connected to a plug port 72 that, in turn, pluggingly engages with a plug connector (not shown) that is electrically connected to the power source 32 (shown in FIG. 1). The substrate 62, in the exemplary implementation, comprises a metal-core printed circuit board, here including nonconductive upper and lower surfaces and a conductive layer between the upper and lower surfaces. The conductive, metal-core (or other conductive-material), substrate facilitates conducting away heat energy generated by the light emitters 66 during their operation.

The heat sink 28 is here configured as a truncated conical section having a topside 76 and a bottom side 78. The top side 76 is of dimensions permitting seating of the substrate 62 at the heat sink in abutting engagement. The seating engagement provides for full surface contact between the substrate 62 and the surface 76 of the heat sink, thereby to maximize the contact of the substrate with the heat sink to maximize the conducting away of the heat energy of the substrate of the light source 16.

The side 78 of the heat sink includes a plurality of fins 82 to facilitate dispersion of heat energy. The surface 78 is also configured to be of dimensions to permit positioning of the coolant flow generator, here an electric fan, to abut against the surface 78 and to be affixed in position thereat. Thereby, coolant air generated during operation of the fan forming the coolant flow generator 26 is caused to be incident upon the fins 82 of the heat sink.

When the light source 16 is seated at the heat sink 28 and the fan forming the coolant flow generator is positioned in proximity to the fins 82 of the heat sink, coolant flow is immediately directed upon the fins to dissipate heat energy to facilitate maintenance of substantially-constant, temperature levels at the LED light emitter 66. Problems associated with heating of the LED emitters are less likely to occur as a result.

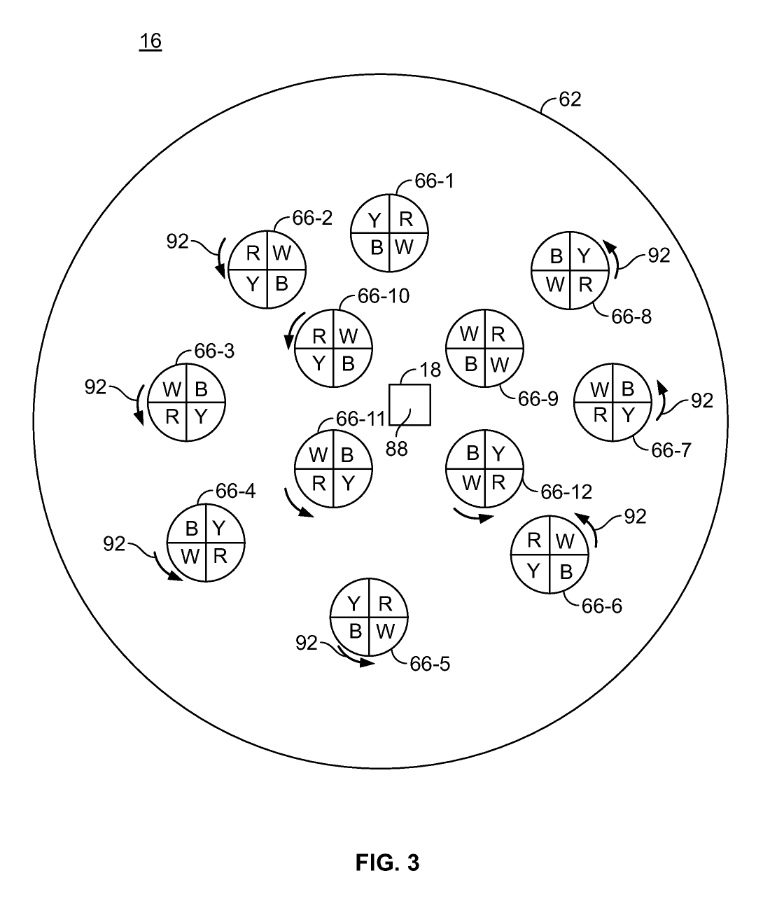

FIG. 3 illustrates the LED light source 16 of an embodiment of the present disclosure that corresponds to the implementation shown in FIG. 2. Again, the LED light emitters 66 are shown to be supported at the substrate 62. And, the substrate, in the exemplary implementation, comprises a multi-layer printed circuit board including a conductive layer positioned between top and bottom, non-conductive layers. Each emitter 66 is comprises multiple light-emitter elements. Specifically, each element comprises a quad LED element having four LED emitters.

Here, each quad LED element comprises a red (R) emitter, a yellow (Y) emitter, a blue (B) emitter, and a white (W) emitter. The emitters 66 are arranged in the implementation shown in FIG. 3 in a circular array centered about a center point 88 at which the temperature sensor 18 is also positioned. In this exemplary implementation, the array comprises a twelve-element array including an outer-ring of emitters and an inner-ring of elements. Each of the elements is positioned radially equidistant from one another in the illustrated embodiment. That is to say, in the outer ring comprised of eight elements, the elements are spaced apart by forty-five degree spacings from one another. And, the inner ring, here comprised of four light-emitter elements, the radial spacing is 180 degrees. That is to say, the light-emitter elements of the inner ring of the circular array are spaced apart from one another by 180 degrees.

Additionally, individual ones of the light-emitter elements are rotationally offset from one another. The arrows 92 are representative of exemplary relative rotations of individual ones of the light-emitter elements relative to next-adjacent elements. For instance, the element 66-1 illustrates the element to be formed of four LED emitters, with the red LED emitter positioned in a first quadrant. The adjacent element 66-2 is rotated by a ninety-degree rotation such that the white emitter is in the first quadrant. And, analogously, the next-adjacent is further rotated by ninety degrees such that the blue emitter is in the first quadrant. Others of the emitters are analogously rotated. Through such rotation of the elements relative to one another, improved color mixing is provided.

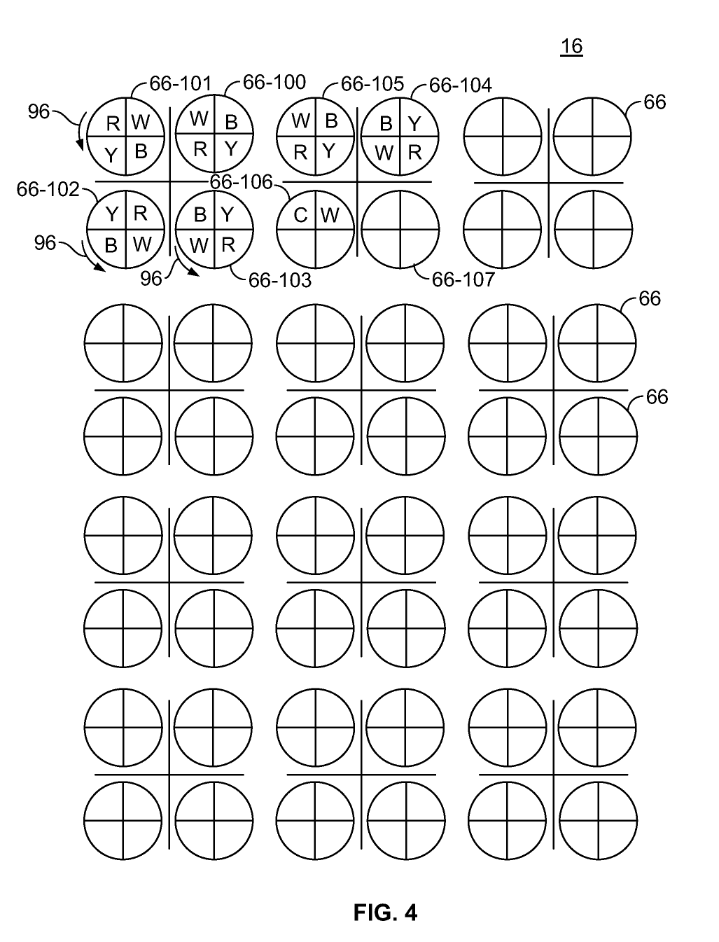

FIG. 4 illustrates the light source 16 of an alternate implementation. In this implementation, once again, the light source is comprised of a plurality of quad LED elements. Here, 12 two-by-two arrays are utilized, which each array having four quad LED elements. Each of the elements is rotationally offset, here indicated by the arrows 96, from one another. Here, the elements are rotationally set off by 90 degrees from one another. For instance, with respect to the upper, left-most (as shown) two by two array of four light-emitter elements, the light emitter 66-100 is positioned such that a blue LED emitter is positioned in a first quadrant. The light emitter 66-101 is rotated such that the emitter is positioned in the first quadrant. The elements 66-102 and 66-103 of the array are further rotated by additional ninety degree increments.

Additionally, in the implementation of the light source 16 shown in FIG. 4, adjacent ones of the arrays are additionally offset from one another. With respect to the top, center-most (as shown) array, the elements are offset relative to the next-adjacent one of the arrays. Here, for instance, the element 66-104 has a yellow light emitter positioned in its first quadrant. This rotational orientation of the element corresponds to the element 66-103 of the first array. And, analogously, the emitter 66-105 corresponds in orientation to the orientation of the emitter 66-100 of the first array.

Improved color mixing is provided through the rotational positioning of the individual ones of the quad LED emitters. That is to say, the rotational positioning of the LED light emitters provides a lamp output of improved chromatic consistency. And, when the light energy of the lamp output is incident upon an object, the object is more uniformly lighted with a uniform color of light.

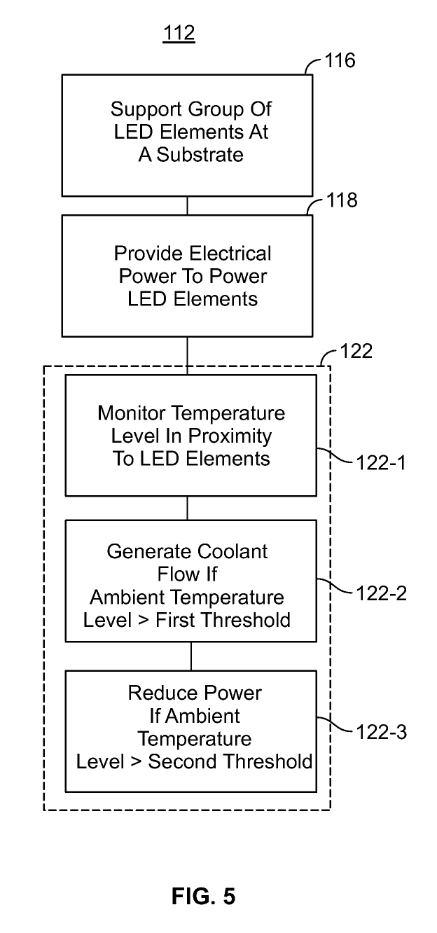

FIG. 5 illustrates a method flow diagram, shown generally at 112, representative of the method of operation of the embodiment of the present invention. The method facilitates generation of color-mixed light. First, and as indicated by the block 116, a group of multiple LED elements is supported at a substrate. The elements are supported at the substrate in an array configuration in which each multiple LED element is comprised of multiple LED light emitters. Individual ones of the LED elements of the group are rotationally offset from others of the group. Then, as indication by the block 118, electrical power is provided to power the multiple LED elements.

Then, and as indicated by the blocks 122, the temperature level proximate to the LED elements are maintained. At the block 122-1, the temperature level in proximity to the LED elements is monitored. Then, and as indicated by the block 122-2, if the temperature level is greater than a first threshold, coolant flow is generated to dissipate thermal energy to the LED elements. And, as indicated by the block 122-3, if the monitored temperature level exceeds a second threshold, the power level applied to the light emitters is reduced.

Thereby, color-mixed light, generated by LED light emitters is generated while maintaining the temperature levels of the LED light emitter elements at a constant temperature or within a range of temperatures, thereby to maintain the color output of the generated light energy.

Presently preferred embodiments of the invention and many of its improvements and advantages have been described with a degree of particularity. The description is a preferred example of implementing the invention and the description of the preferred examples is not necessarily intended to limit the scope of the invention. The scope of the invention is defined by the following claims:

1. An apparatus for regulating a temperature level at a light assembly having an LED, light emitting diode, light source, said apparatus comprising:
a temperature sensor positioned in proximity to the LED light source, said temperature sensor configured at least to sense when a temperature level at the LED light source exceeds a high temperature threshold;
a coolant flow generator configured to generate coolant fluid flow responsive to sensing by said temperature sensor that the temperature level exceeds the high temperature threshold, thereby to regulate the temperature level at the LED light source.

2. The apparatus of claim 1 wherein said temperature sensor and said coolant flow generator are arranged in a feedback configuration to regulate the temperature level at the LED light source at a substantially constant level.

3. The apparatus of claim 1 wherein the LED light source comprises LED light elements mounted at a substrate and wherein said apparatus further comprises a heat sink of dimensions permitting seating engagement of the substrate thereat.

4. The apparatus of claim 3 wherein said heat sink further comprises, and is integrally formed with, a light assembly housing.

5. The apparatus of claim 3 wherein said housing is positioned between the substrate and said coolant flow generator.

6. The apparatus of claim 5 wherein said housing is further of dimensions permitting seating engagement of said coolant flow generator thereat.

7. The apparatus of claim 1 wherein said coolant flow generator comprises a motorized fan.

8. The apparatus of claim 1 further comprising a power controller configured to control a power level of power applied to the LED light.

9. The apparatus of claim 8 wherein said temperature sensor is further configured to detect rise in the temperature level at the LED light source subsequent to generation of the coolant fluid flow by said coolant flow generator.

10. The apparatus of claim 9 wherein said power controller is configured to reduce the power level of the power applied to the LED light when said temperature sensor detects the rise in the temperature level at the LED light source subsequent to the generation of the coolant fluid flow by said coolant flow generator.

11. The apparatus of claim 1 wherein the LED light source comprises a plurality of LED elements, said apparatus further comprising a substrate configured to support the LED elements of the plurality in an arrangement defining an array.

12. The apparatus of claim 11 wherein the LED elements comprise quad LED elements, each quad LED element comprised of four LED emitters, the array comprising at least one group of quad LED elements with individual ones of the quad LED elements of the group rotationally offset from others of the group.

13. The apparatus of claim 11 wherein the array comprises a rectangular array.

14. The apparatus of claim 11 wherein the array comprises a circular array.

15. An apparatus for a light assembly, said apparatus comprising:
a group of multiple LED, light emitting diode elements, each multiple LED element comprised of multiple LED light emitters; and
a substrate configured to support the multiple LED elements of said group in an array configuration, individual ones of the multiple LED elements of said group rotationally offset from others of said group.

16. The apparatus of claim 15 wherein the multiple LED elements comprise quad LED elements comprised of four LED light emitters and wherein the individual ones of the quad LED elements of said group rotationally offset from others of said group by substantially quarter turns.

17. The apparatus of claim 15 wherein the individual ones of the multiple LED elements are rotationally of set from others of said group by amounts related to the number of LED elements of the multiple LED light emitters.

18. The apparatus of claim 15 wherein said substrate is configured to support the multiple LED elements of said group in a circular array configuration.

19. A method for generating color-mixed light, said method comprising:
supporting a group of multiple LED, light emitting diode, elements at a substrate, at a substrate in an array configuration, each multiple LED element comprised of multiple LED light emitters, individual ones of the multiple LED elements of the group rotationally offset from others of the group; and
providing electrical power to power the multiple LED elements.

20. The method of claim 19 further comprising maintaining temperature levels proximate to the group of multiple LED elements.
